(19) United States
(12) Patent Application Publication
(10) Pub. No.: US 2008/0105581 A1
(43) Pub. Date: May 8, 2008

(54) Liquid Holder Linked Body, Method For Producing Liquid Holder Linked Body Into Which A Liquid Has Been Infused, And Apparatus For Producing Liquid Holder Linked Body Into Which A Liquid Has Been Infused

(75) Inventors: Yoshiaki Kondo, Sendai-shi (JP); Hideyuki Momoi, Osaka-shi (JP); Yutaka Takashi, Osaka-shi (JP)

Correspondence Address: GLOBAL IP COUNSELORS, LLP, 1233 20TH STREET, NW, SUITE 700, WASHINGTON, DC, 20036-2680, US

(73) Assignee: NIPRO CORPORATION, Osaka-shi (JP)

(21) Appl. No.: 11/597,374

(22) PCT Filed: May 26, 2005
(86) PCT No.: PCT/JP05/09616

§ 371 Date: Jul. 5, 2007

(30) Foreign Application Priority Data
May 26, 2004 (JP) 2004-155510

(51) Int. Cl. B65B 3/04; A61J 1/05; B65D 21/02

(52) U.S. Cl. 206/438; 220/23.4; 53/266.1; 53/467

(57) ABSTRACT

A liquid holder linked unit 1 that includes a plurality of liquid holders connected together. Each liquid holder is used as a liquid container suitable for easily dispensing chemicals by a proper amount for each use according to patients with a precise recipe includes an open inlet 11 and an open outlet 12, and plurality of liquid holders 101, 102, and 103 capable of storing the chemicals by an amount for each use formed between the inlet and the outlet. Outlet 12 of one liquid holder linked units is detachably fitted to the inlet 11 of another liquid holder linked unit to integrally connect the plurality of liquid storage part connection unit bodies to each other. With all liquid holder linked units 1 between the first inlet 11 and the last outlet 12 allowed to communicate with each other, the chemicals are filled therein and the portions of the communication pipes 13 thereof are scaled to store specified amounts of chemical therein.

### TECHNICAL FIELD

The present invention relates to a liquid container used to hold individual portions of various kinds of liquid, and to a method for producing a product in which a liquid has been infused into this liquid container, and to an apparatus for producing a liquid holder linked body into which a liquid has been infused.

### BACKGROUND ART

Drugs for injection, for example, are provided by the pharmaceutical industry in a form in which they have been aliquoted in unit volumes into glass ampoules or plastic containers. At the present time, this aliquoting step entails a tremendous amount of labor in the pharmaceutical industry.

Meanwhile, the single dosage of oral drugs depends on the age of the patient, which makes it difficult for the pharmaceutical industry to provide them in a form in which they have already been aliquoted into small containers, and the standard practice at [Japanese] pharmacies is for the requisite number of days' worth of various kinds of drug to be mixed in a single plastic bottle. These plastic bottles are graduated, and the patient uses these graduations to take a single dose as prescribed by a physician, pharmacists, etc.

In addition, parenterally administered liquids, drug solutions used for ear, nose, and throat, collutories that are not swallowed but are used for disinfection, disinfectants used in the course of surgery and other such treatments, cleaning solutions used to clean contact lenses and the like, bodily fluids used for testing, and other such liquids are also frequently used in specific amounts, and here again, the normal practice is to use these in their designated one-time amounts.

However, to use oral drug solutions as an example, a method that involves the above-mentioned aliquoting makes it difficult for the user to take an accurate single dose of the prescribed drug because the amount is measured by eye. Particularly when granules of an antibiotic or the like are prescribed to be mixed into a drug solution, it is a common occurrence for there to be sediment on the bottom of the plastic bottle. If a patient were to take the drug without first mixing it well, the administered dose of granules each time would be drastically reduced, or conversely increased, for example, so such a situation is undesirable in terms both of the therapeutic effect and of side effects.

Other problems are encountered in terms of pharmaceutical management, i.e., the drug solution contained in a plastic bottle is prone to spilling, and germs can get into the bottle while it is being stored by a patient due to improper aliquoting performed by the patient.

It is also possible to provide a drug by prescribing that a single dose be put ahead of time into a small container according to the age and other conditions of the patient, but pouring the drug a dose at a time into small containers involves a great deal of work for the prescriptionist. There is therefore a need for a method with which a prescriptionist can easily dispense the required amount of drug into a drug solution holding container.

A packaging container has been disclosed in Design Registration 1,200,042, wherein containers that have been filled with a single-use amount of liquid are manufactured continuously, and at their time of use these containers are cut off one at a time (see Patent Document 1, for example). With this packaging container, the drug or other liquid is dispensed into the packaging container from a cylindrical filling component that protrudes to the bottom of the container, and after the container has been filled the cylindrical filling component is cut and heat-fused, so that the cut portion is sealed.

With the packaging container disclosed in Design Registration 1200042, however, the filling liquid is dispensed from a cylindrical filling component that protrudes to the bottom, through the ordinary container supply opening, or through the supply opening of a dispensing apparatus. When this packaging container is used, in the case of a liquid such as small amount of medicine at a hospital or pharmacy, as discussed above, there is no doubt that the dispensing takes a great deal of time and effort. When a large quantity of liquid is supplied and aliquoted, the apparatus must also be larger in scale. Furthermore, when this packaging container is used, since there is always a gap between the individual filling components and the container or filling apparatus supply opening, there is always the apprehension that germs or dust or other such contaminants will get in through this gap, so this situation is far from being hygienic.

The present invention provides a method for producing a liquid holding body in which a drug solution or other liquid is held in a liquid holding container for holding a single-use amount of drug, and one or more of these liquid holding containers filled with liquid are included. Specifically, the present invention was conceived in light of the above situation, and it is an object thereof to provide a liquid container into which a single-use amount of liquid corresponding to the intended application can be aliquoted with relative ease, and a method for producing a product in which a liquid has been infused into this liquid container, and an apparatus for producing a liquid holder linked body into which a liquid has been infused.

Patent Document 1: Design Registration 1,200,042

### DISCLOSURE OF THE INVENTION

As a result of diligent research aimed at solving the above problems, the inventors arrived at the present invention upon discovering that the above problems can be solved by using a container in which a plurality of liquid holders having a volume large enough to hold a single-use amount of liquid are linked in a communicating state, closing off the communicating portions after a liquid has been infused into this linked body at a preliminary stage such as the filling of a prescription, and producing liquid containers into each of which a single-use amount of liquid has been aliquoted.

Specifically, the present invention is:

(1) A liquid holder linked body, comprising liquid holder linked units each provided with an open inlet, an open outlet, and a plurality of liquid holders capable of holding a single-use amount of liquid, wherein the outlet of one liquid holder linked unit is detachably fitted to the inlet of another liquid holder linked unit to integrally connect a plurality of liquid holder linked units together, and all of the liquid holder linked units from the first inlet to the last outlet communicate with each other. The liquid that is held can be a drug, a bodily fluid, a flushing liquid, or a diet liquid such as a food additive or a flavoring, so [the present invention] has wide applicability.

The method for producing a liquid holder linked body into which a liquid has been infused pertaining to the present invention can also be as in (2) to (5) below.

(2) A method for producing a liquid holder linked body into which a liquid has been infused, wherein, using a liquid holder linked body comprising liquid holder linked units each provided with an open inlet, an open outlet, and a plurality of liquid holders capable of holding a single-use amount of liquid, in which the outlet of one liquid holder linked unit is detachably fitted to the inlet of another liquid holder linked unit to integrally connect a plurality of liquid holder linked units together, and all of the liquid holder linked units from the first inlet to the last outlet communicate with each other, a liquid is infused into the entire liquid holder linked body through the first inlet, after which the communicating portions between adjacent liquid holders of all the liquid holder linked units, and the communicating portions from the liquid holders of each liquid holder linked unit to the inlet and outlet of that liquid holder linked unit are closed off, and a single-use amount of liquid is infused into all of the liquid holders.

(3) The method for producing a liquid holder linked body into which a liquid has been infused according to (2) above, wherein the closure of the communicating portions between adjacent liquid holders of all the liquid holder linked units, and the communicating portions from the liquid holders of each liquid holder linked unit to the inlet and outlet of that liquid holder linked unit is accomplished by heat-sealing the outer wall material that makes up the communicating portions, thereby blocking off these portions.

(4) An apparatus for producing a liquid holder linked body into which a liquid has been infused by the method for producing a liquid holder linked body into which a liquid has been infused according to (2) or (3) above, using the liquid holder linked body according to (1) above.

(5) The apparatus for producing a liquid holder linked body into which a liquid has been infused according to (4) above is, more specifically, an apparatus for producing a liquid holder linked body into which a liquid has been infused, provided with support means for setting in a specific position a liquid holder linked body comprising a plurality of connected liquid holder linked units, closure means for closing off the communicating portions provided to the liquid holder linked units and thereby sealing in the liquid infused into the individual liquid holders, and movement means for moving the support means and closure means relative to each other and thereby positioning them at the closed-off places of the targeted liquid holder linked units.

The effect of the present invention will be particularly pronounced when the aliquoting from a stock solution, including any compounding as needed, is an operation that requires the handling of a liquid, such as when the usage volume needs to be fairly accurate in oral or parenteral administration of medical liquids such as drug solutions or bodily fluids, or when liquids need to be compounded in individual amounts depending on differences in the patients using them, or when a small amount is dictated by the situation in which the liquid will be used. More specifically, the above-mentioned liquids include injected drug solutions, ingested drug solutions, antiseptic drug solutions, and biological liquids such as serum. Accordingly, the liquid holders of the liquid holder linked body in the present invention must not only afford accurate aliquoting, but must also be liquid containers that allow the aliquoting of single doses with relative ease in a clean form, for when particular import is placed on preventing the admixture of germs and so forth in medical, food, and other such applications, or at least on not inviting the proliferation of bacteria.

The present invention is also a method for manufacturing a liquid holding body comprising a liquid holding container and a liquid that is held inside said liquid holding container,

wherein a plurality of said liquid holding containers are connected to a liquid channel,

the plurality of connected liquid holding containers are disposed so that the liquid channel is below and an opening is above,

the opening functions as a vent hole,

the liquid holding body which includes one or more liquid holding containers and in which a specific amount of liquid has been infused into the liquid holding containers is obtained by conducting,

a step of allowing a liquid to flow into a liquid channel and thereby causing the liquid to flow into each of the disposed liquid holding containers, and

a step of halting the flow of liquid at the point when the liquid level reaches a specific position in each liquid holding container are performed, and

a step of closing off said liquid channel and a step of closing off the openings of the liquid holding containers are performed after the flow of liquid has been halted. Using this method for manufacturing a liquid holding body allows a specific amount of liquid to be infused into a liquid holding container with ease, and allows a liquid holding body to be obtained simply, even at a hospital, pharmacy, or the like.

Furthermore, the present invention is a liquid holder linked body or liquid holding body into which a liquid has been, wherein the liquid holders or liquid holding containers are pressed to contract their volume, after which a drug solution or other liquid is infused, after which this pressing is released and the liquid is infused into the liquid holder linked body or liquid holding containers.

For example, in infusing a liquid that is a drug solution into a plurality of liquid holding containers, even when this liquid is adjusted to a total volume obtained by multiplying the volume of one drug solution holding container by the number of containers, and is adjusted so as to be held in the liquid holding containers, since the various liquid holding containers communicate with each other in parallel, there may be occasions when the last liquid holding container does not hold enough of the liquid. When this happens, the treatment effect is diminished because a smaller amount of medicine ends up being taken in one dose. To prevent this from happening, the amount of liquid infused into the various liquid holding containers is adjusted. However, if the liquid is infused into the liquid holding containers before the liquid is held in the liquid holding containers and after the liquid holding containers have been pressed, so that the volume of the pressed liquid holding containers is contracted and is less than the above-mentioned total volume or the previously adjusted amount of liquid, even then it will be easy for all of the liquid holding containers to hold the same amount of liquid. Also, a state in which the liquid holding containers contain different volumes of liquid can be easily obtained in a single operation by varying how much certain drug solution holding containers are pressed. Furthermore, with the method of the present invention for manufacturing a liquid holding body, a liquid holding body with an adjusted amount of liquid can also be obtained by pressing the liquid holding containers while they contain liquid so as to adjust the amount of liquid in the containers, and then releasing this pressing.

Specifically, a liquid holding body or liquid holder linked body with an adjust amount of liquid can be easily obtained by pressing the liquid holders or liquid holding containers so that the liquid is held in the liquid holders or liquid holding containers.

In the embodiments of the invention given below, the description will be of applications intended to embody an ingested drug solution or an antiseptic drug solution, but the present invention can be similarly applied to injected drug solutions, the above-mentioned bodily fluids, flushing liquids, diet liquids, and so forth.

With the present invention, the outlet of one liquid holder linked unit is detachably fitted to the inlet of another liquid holder linked unit to integrally connect a plurality of liquid holder linked units together, all of the liquid holder linked units from the first inlet to the last outlet communicate with each other, a liquid is infused into this entire liquid holder linked body, and the communicating portions between adjacent liquid holders of all the liquid holder linked units, and the communicating portions from the liquid holders of each liquid holder linked unit to the inlet and outlet of that liquid holder linked unit are closed off, so that a plurality of liquid holding containers are obtained in which a single-use amount of liquid is infused substantially accurately into the various liquid holder units. As a result, the prescriptionist can accurately aliquot a single-use amount of liquid in the specified dose according to the symptoms of the patient, and furthermore, since a plurality of liquid holder linked units are communicating with each other at the stage of infusing the liquid, the liquid infusion procedure is extremely simple.

Also, a drug can be prescribed in an accurate blend amount according to the symptoms, without the patient having to measure a single dose of a prescribed drug by eye from a plastic container or the like, so the optimal therapeutic effect can be obtained, and there will be no unevenness in the amounts in which some components, such as settled components, are ingested, so these components will not be taken in too small an amount, nor will there be side effects caused by taking them in too large an amount. Furthermore, since the patient does not break the seal until the drug is to be used, no bacteria can get into the drug during its storage, and the drug solution will not be accidentally spilled during its handling, so this system is hygienic and also solves problems associated with pharmaceutical management.

In addition, accurate aliquoting can be accomplished with a simple operation, so the time-consuming aliquoting work performed by not only by pharmaceutical manufacturers, but also prescriptionists in hospitals, pharmacies, and so forth, is greatly improved, and since a plurality of liquid holder linked units (according to the number required) are connected and communicate with each other, the infusion of the same liquid can be carried out all at once, allowing large quantities of liquid to be aliquoted efficiently and in a short time, which greatly enhances work efficiency.

With the apparatus for producing a liquid holder linked body into which a liquid has been infused pertaining to the present invention, and particularly a small-scale, simple type of apparatus such as that described in detail in the following embodiments, the effect is particularly pronounced when the aliquoting from a stock solution, including any compounding as needed, is an operation that requires the handling of a liquid, such as when the liquids need to be compounded in individual amounts depending on differences in the patients using them, or when a small amount is dictated by the situation in which the liquid will be used. Therefore, the present invention is extremely useful in that it allows for very personalized care in filling the prescriptions of patients, even at small clinics, pharmacies, and so forth. Furthermore, this effect is also realized when a single type of specimen is available in a limited quantity, such as bodily fluids used for testing and other such liquids. Moreover, it should go without saying that even in the case of liquids that are handled in large quantities, such as parenterally administered liquids, drug solutions used for ear, nose, and throat, collutories that are not swallowed but are used for disinfection, disinfectants used in the course of surgery and other such treatments, cleaning solutions used to clean contact lenses and the like, and other liquids that are frequently used in a specific amount, an effect will be realized as an efficient liquid aliquoting apparatus, with a manufacturing apparatus on a scale corresponding to the amount to be produced.

### BRIEF DESCRIPTION OF THE DRAWINGS

FIG. 1 is a cross section of a liquid holder linked unit pertaining to an embodiment of the liquid holder linked body of the present invention;

FIG. 2 is a diagram illustrating the state when a liquid has been infused into the liquid holder linked unit shown in FIG. 1;

FIG. 3 is a diagram illustrating the state when the communicating portions of the liquid holder linked unit shown in FIG. 2 have been closed off to seal in the liquid, after which one of the liquid holder linked units has been separated;

FIG. 4 is a diagram illustrating the state when a twist-off tab of the liquid holder container shown in FIG. 3 has been twisted off;

FIG. 5 is a diagram illustrating an example of an embodiment of the method and apparatus of the present invention for producing a liquid holder linked body into which a liquid has been infused;

FIG. 6 is an oblique view of the manufacturing apparatus used in the embodiment of FIG. 5, in which a pressing mechanism is employed;

FIG. 7 is a simplified oblique view of a first embodiment of the method for manufacturing a liquid holding body of the present invention; and

FIG. 8 is a simplified oblique view of a second embodiment of the method for manufacturing a liquid holding body of the present invention.

### KEY

1 liquid holder linked unit
10 liquid holder container
100 liquid holder container main body
101, 102, 103 liquid holder
11 inlet
12 outlet
13 communicating tube
14 communicating tube connecting part
15 linked part (thin-walled part)
16 gap
17 partition
18 twist-off tab
181 marking
19 linked part (thin-walled part)
191 brittle part
2 liquid
3 sealed part
4 sealing apparatus
41 apparatus main body
42 sealing jig
43 pressing lever
44 hook jig
45 hook
50 liquid supply container
51 supply tube
52 suction tube
53 suction pump
60 first pressing plate
61 second pressing plate
62 liquid holder pressing lever
71 liquid supply container
72 pump
731 to 735 liquid holding containers
741 to 745 openings
75 liquid discharge pipe
761 to 765 communicating portions
77 reservoir tank
81 liquid supply container
82 pump
831 to 835 liquid supply containers
841 to 845 openings
851 to 855 liquid channels
86 reservoir tank

### BEST MODE FOR CARRYING OUT THE INVENTION

The liquid holder linked body and method for manufacturing a liquid holder linked body into which a liquid has been infused of the present invention will now be described in detail through reference to the preferred working examples illustrated in the appended drawings.

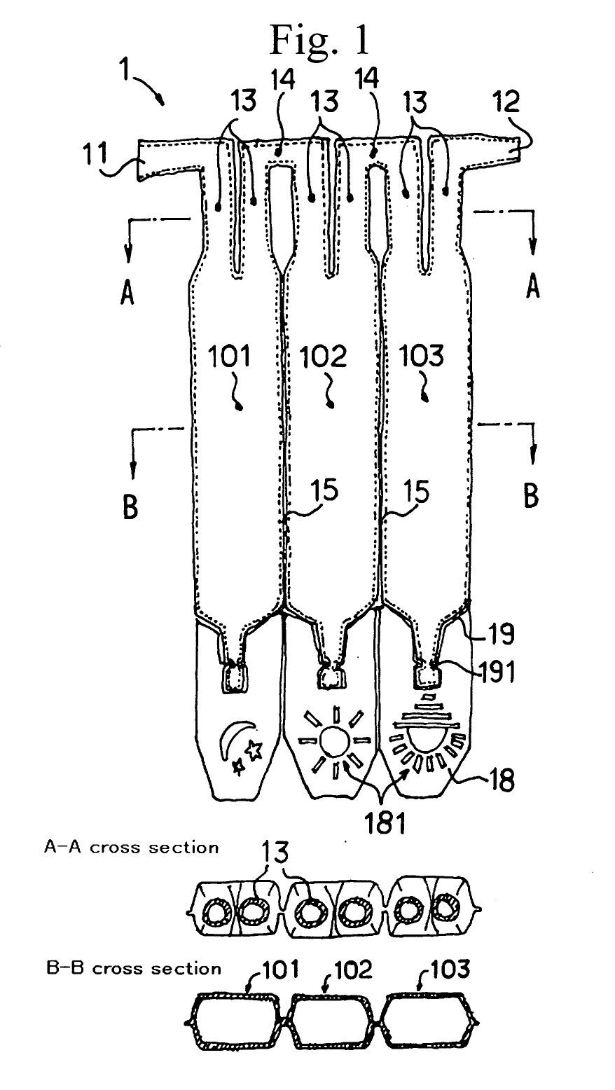

The liquid holder linked unit 1 shown in FIG. 1 has an open compounding inlet 11 provided at one end, an open outlet 12 provided at the other end, and three liquid holders 101, 102, and 103 for holding a drug solution provided in between the inlet 11 and the outlet 12, and communicating with each other via communicating tubes 13 and communicating tube connecting parts 14.

The liquid holder linked unit 1 can be a container entirely produced by integral molding, such as injection molding, blow molding, or vacuum molding, for which thermoplastic synthetic resin, such as a polyolefin or polyester resin is used favorably, but it may also be integrally formed by the secondary working, such as welding, or a thermoplastic synthetic resin material in the form of a sheet or film.

There are no particular restrictions on the type of synthetic resin material, as long as it allows the secondary working of a thermoplastic synthetic resin material in the form of a sheet or film by the above-mentioned injection molding, blow molding, or vacuum molding, but this material may be a composite layer with a functional material that suppresses permeability of air, water, or other specific components in order to prevent air permeation or liquid evaporation, or a material that has undergone an anti-UV treatment or the like to prevent degradation, for example, may be used. If the material is colored, it is preferably one that is translucent so that the contents will be visible.

The dispensing inlet 11 is formed in the shape of a tube, and can be detachably fitted to the outlet 12 (discussed below). [One end of] this inlet 11 is left open so that a connector or the end of a tube for supplying a liquid can be connected, or the nozzle of a syringe (not shown) can be directly inserted, and the other end is linked to a liquid holder 101, and a drug solution or the like is infused through this and held in the plurality of liquid holders. The amount of liquid infused at this time is determined by the number of linked liquid holders. For instance, as in this embodiment, when the liquid holder linked unit 1 consists of three liquid holders (101, 102, and 103), three doses of liquid are infused.

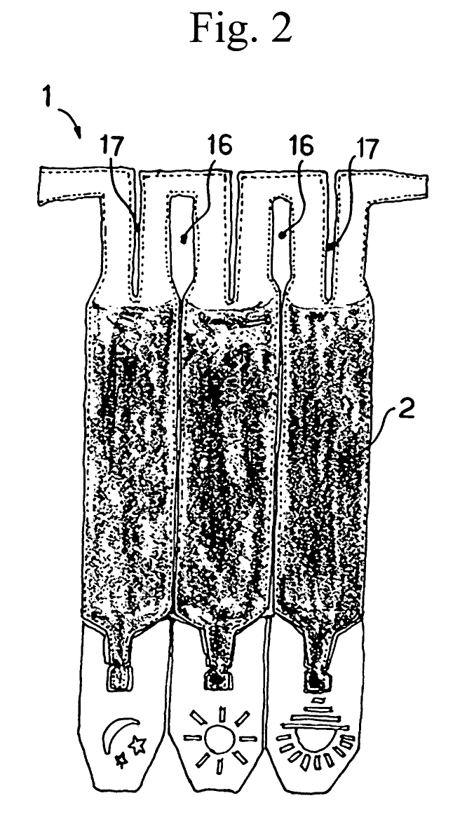

The communicating tube 13 portions of the liquid holder linked unit 1 are clamped, heat-sealed, or otherwise crimped or fused and closed off after the liquid has been infused (FIG. 2).

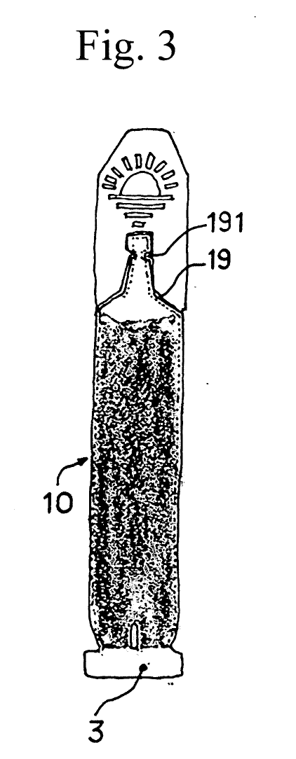

The liquid holder 101 and the liquid holder 102 are linked in a state in which their interiors communicate with each other from the communicating tubes 13 via the communicating tube connecting part 14, and the liquid holder 102 and the liquid holder 103 similarly are lined via the communicating tubes 13 and the communicating tube connecting part 14. Further, these liquid holders 101, 102, and 103 have linked parts 15 where they are only partially linked or are linked by thin-walled portions, for example, with just enough strength that they can be torn apart by hand at the time of use and separated into individual liquid holder containers 10 (FIG. 3).

Here, the sealed parts in which the communicating tubes 13 of the liquid holder linked unit 1 have been closed off by crimping or fusing also have a thin-walled component weak enough to allow adjacent containers to be pulled apart by hand at the time of use, so that liquid holder linked units with attached sealed parts are used after being separated into three liquid holder containers 10 as shown in FIG. 3.

The outlet 12 is formed in a tubular shape in the same manner as the inlet 11, and can be detachably fitted to the inlet 11. One end of this inlet 12 is left open so that the end of a residual liquid tube or a connector to a residual liquid container can be connected, and the other end is linked to the liquid holder 103. As will be discussed below, the reason for leaving the outlet 12 open is so that air can be discharged from this opening and the liquid holders 101, 102, and 103 filled uniformly with liquid.

As discussed above, the liquid holder linked unit 1 is designed so that the inlet 11 and the outlet 12 can be detachably fitted together, so when the required number (as dictated by the prescription) of liquid holder linked units 1 are connected and integrated, all of the liquid holder linked units from the first inlet to the last outlet communicate with each other, and thus the required amount of liquid can be uniformly aliquoted to all of the liquid holders constituting the linked liquid holder linked units.

Specifically, with this embodiment, liquid is supplied from the inlet 11 of the liquid holder linked unit 1, sent from the communicating tube 13 into the liquid holder 101, and moves from the communicating tube 13 on the opposite side from the inlet side, through the communicating tube connecting part 14 at the upper part in FIG. 1, then through the communicating tube 13 that leads to the liquid holder 102, into the liquid holder 102, and then on to the subsequent liquid holders.

Here, in the example of this embodiment, the inlet 11 has a larger diameter than the outlet 12, so that liquid holder linked units 1 are connected together by fitting the outlet 12 of one liquid holder linked unit 1 into the inlet 11 of the next liquid holder linked unit 1, but the diameter relationship between the inlet and outlet may be reversed from that in this embodiment.

The step of aliquoting liquid to the liquid holder linked unit 1 will now be described through reference to FIGS. 1 to 4. (It shall be assumed that the operation is in the up and down direction shown in the drawings.)

(1) A nozzle provided to a container filled with liquid, such as a syringe, or a connector or the end of a tube for supplying liquid, is connected to the inlet 11, and a liquid 2 is extruded.

(2) After all of the liquid in the liquid supply container has been infused, air is sent into the liquid holder linked unit 1 to fill the communicating tubes 13 at the upper part in FIG. 2 with air.

(3) With the liquid holder linked unit held in this up and down orientation, the communicating tube portions, two of which are formed at the upper part of the liquid holders 101, 102, and 103, are closed off by crimping or fusing with a clamp, heat sealer, or the like.

(4) Everything on the communicating tube connected side, from the sealed parts formed in the above closing-off step forward, is separated and discarded to obtain a liquid holder linked unit attached sealed parts, consisting of linked liquid holders 101, 102, and 103 having the sealed parts 3 formed at one end, as shown in FIG. 3. (The linked unit is not shown with the sealed parts attached.)

The step in which everything on the communicating tube connected side, from the sealed parts on, is separated and discarded is preferably conducted more efficiently by being conducted simultaneously with the closing-off step in (4) above.

(5) The liquid holder linked unit with attached sealed parts, consisting of the liquid holders 101, 102, and 103 filled with liquid, is separated at time of use into the three liquid holder containers 10 shown in FIG. 3 by pulling apart by hand the seal parts formed by crimping or fusing of the communicating tube portions and the linked parts 15 at which the liquid holders are linked.

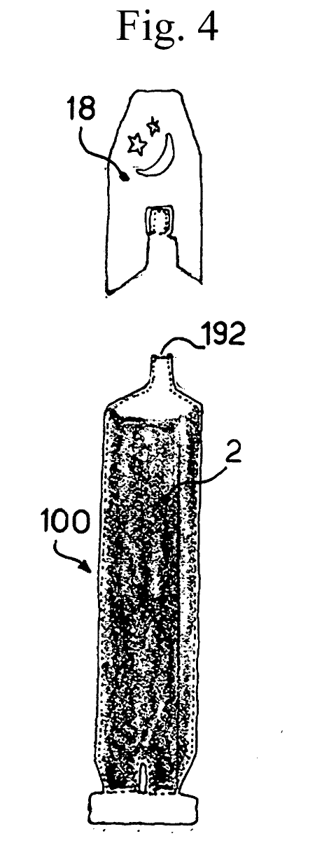

(6) A twist-off tab 18 formed via a linked part 19 (formed only partially linking or linking by thin-walled portions with just enough strength that they can be torn apart by hand) of the liquid holder container 10 is twisted off, which gives a liquid holder container main body 100 having an opening 192 that allows the liquid to be taken out when a brittle part 191 is snapped off as shown in FIG. 4. This allows the liquid to be administered or used for another purpose.

In step (2) above, as air is being pumped in after the liquid has been supplied from the inlet 11, because a partition 17 is formed between the communicating tubes 13, two of which are formed at the upper part of each of the liquid holders 101, 102, and 103, the level of the liquid 2 is aligned with the bottom ends of the communicating tubes 13 as shown in FIG. 2. In the next step, air is suitably infused by closing off the communicating tubes 13, so the liquid level ends up being located slightly lower than the opening 192 of the liquid holder container main body 100 in which the liquid 2 is held, as shown in FIG. 4, and this keeps the liquid 2 from splashing out or spilling when the twist-off tab 18 is twisted off and the opening 192 is opened. The volume of air infused along with the liquid 2 can be easily adjusted by controlling the position of the seal that closes off the passage, or by the length or inside diameter of the communicating tubes 13.

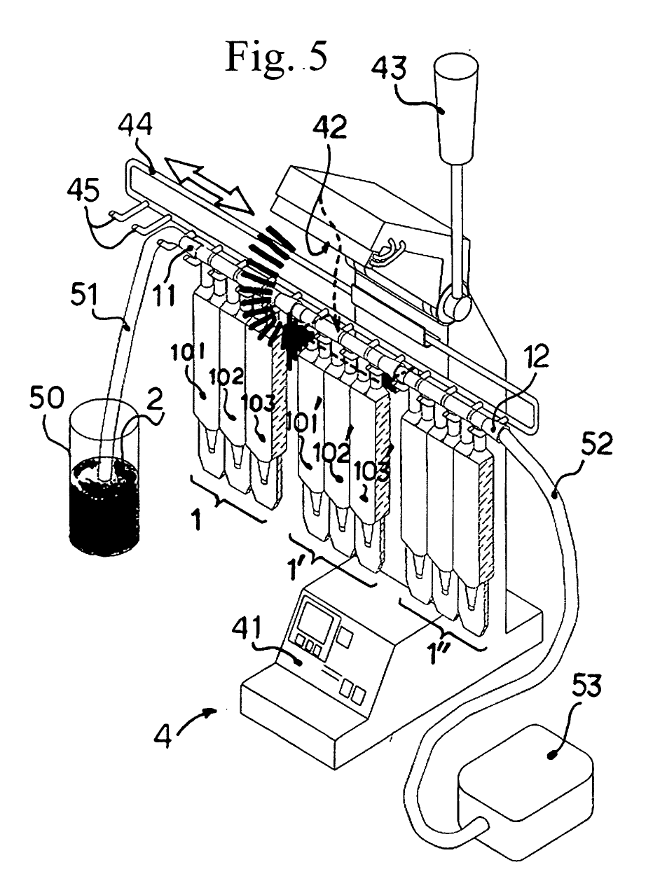

In the above description of the step of aliquoting liquid into the liquid holder linked unit 1, the description was of infusing from a container filled with a liquid, such as a syringe, and connected to the first inlet 11, but another possible method for infusing is illustrated by the example of an embodiment of a manufacturing apparatus in FIG. 5, in which a suction apparatus or the like is connected to the last outlet 12 to put the interior of the liquid holder linked body under negative pressure, and the liquid is infused by suction from a liquid supply container connected to the first inlet 11.

Also, as shown in FIGS. 1 to 4, it is convenient for information related to the prescription or the contents of the liquid 2 to be displayed on the twist-off tab 18, and in this embodiment, markings 181 indicating “morning,” “noon,” and “night” are displayed on the liquid holder linked unit (set of three) with attached sealed parts, consisting of three liquid holders holding one day's worth of drug solution or the like to be given to the patient.

The number of linked liquid holders is not limited to the three used in this embodiment, and it should go without saying that the present invention may be applied to any number. The volume of the liquid holders may also be matched to the daily routine of the patient, and the present invention can of course also be applied to variations such as when the volume of the “night” dose is greater than the other doses, for example.

Also, in the above embodiment, a configuration was described in which the opening 192 that allowed the liquid in the liquid holder container 10 to be taken out was opened by twisting of the twist-off tab 18 formed via the linked part 19, but in working the present invention, a sealing configuration involving a screw-on cap, or another sealing configuration, can also be used for the opening allows the liquid to be taken out.

Finally, an embodiment of a manufacturing apparatus for producing a liquid holder linked body into which a liquid has been infused, produced according to the production method pertaining to the present invention, will be described through reference to FIG. 5.

The manufacturing apparatus described here is a simple type of relatively small scale, to which the present invention is applied and a very pronounced effect is achieved. This is extremely useful in that it allows for very personalized care in filling the prescriptions of patients at small clinics, pharmacies, and so forth, but even in the case of handling liquids supplied in large quantities by frequently using the liquids in specific amounts, this manufacturing apparatus can be used to produce liquid holder linked bodies in which liquids are aliquoted efficiently, supported by automated equipment or the like of a scale corresponding to the amount to be produced, affording better productivity, and this is also encompassed by the constitution of the present invention.

The manufacturing apparatus for producing a liquid holder linked body into which a liquid has been infused pertaining to the present invention has a basic constitution that comprises support means for setting in a specific position a liquid holder linked body consisting of a plurality of the above-mentioned connected liquid holder linked units 1, closure means for closing off the communicating portions provided to the liquid holder linked units 1 and thereby sealing in the liquid infused into the individual liquid holders, and movement means for moving the support means and closure means relative to each other and thereby positioning them at the closed-off places of the targeted liquid holder linked units, as necessary.

The liquid holder linked unit 1 used in the sealing apparatus 4 of the embodiment shown in FIG. 5 is the liquid holder linked unit 1 configured as shown in FIG. 1, wherein the liquid holders communicate with each other such that the liquid circulates through the liquid holders 101, 102, and 103 in order, and gaps 16 are formed between the plurality of communicating tubes 13.

The sealing apparatus 4 comprises closure means consisting of a pair of sealing jigs 42 provided to an apparatus main body 41, support means provided as a hook jig 44 from which protrude a plurality of hooks 45 for latching the gap 16 portions formed in the liquid holder linked unit 1, and movement means for moving the support means and closure means relative to each other and thereby positioning them at the closed-off places of the targeted liquid holder linked units.

Known technology, such as clamping or heat sealing by some physical means, can be used favorably as the closure means, and the liquid is sealed in the liquid holders in which it is held by crimping or fusing to close off the communicating tubes 13 formed in the liquid holder linked unit 1.

With this embodiment, the parallel portions of the communicating tubes 13 formed in the liquid holder linked unit 1 are disposed so as to be positioned between the pair of sealing jigs 42 provided to the apparatus main body 41, and are crimped or fused by a pressing lever 43.

In this embodiment, the support means is provided with the hook jig 44 from which a plurality of hooks 45 protrude, the liquid holders 101, 102, and 103 constituting the liquid holder linked unit 1 face downward, the communicating tube 13 portions communicating between the liquid holders face upward, and in FIG. 5 the gap 16 portions formed in the liquid holder linked unit 1 are latched on the hooks 45 in a state in which three of [the liquid holders] are connected. The plurality of connected liquid holder linked units are held in specific positions, a supply tube 51 coming from a liquid supply container 5 is connected to the inlet 11 of the first liquid holder linked unit 1, and the liquid 2 is infused. In this embodiment, a suction tube 52 is attached to the outlet 12 of the last liquid holder linked unit 1″, and the liquid passing through the liquid holders of the three connected liquid holder linked units 1 to 1″ is suctioned by a suction pump 53.

In the configuration described above, the support means involved latching the gap 16 portions formed in the liquid holder linked units 1 to the hooks 45, but as long as it is possible to support the liquid holder linked body composed of a plurality of liquid holder linked units connected at the intended position and in a specific orientation in the closure step, the support means is not limited to just this embodiment.

In this embodiment, the movement means for moving the support means and closure means relative to each other and thereby positioning them at the closed-off places of the targeted liquid holder linked units was capable of horizontal movement to the left and right, while maintaining a state in which the communicating tube 13 portions could be positioned exactly between the pair of sealing jigs 42 of the closure means while in a parallel state, so that the hook jig 44 from which a plurality of hooks 45 protruded could perform the closure step for each of the liquid holder linked units 1, 1′, and 1″.

The unit of movement here was [the length] of each individual liquid holder linked unit 1, 1′, or 1″, but a closure step may be provided for a plurality of connected liquid holder linked units all at once, and the movement means is not necessarily an essential constituent requirement, and the present invention is applicable even in such a case. For instance, such a case would be when the apparatus is designed such that the positional relationship with the closure means is set in a state in which a plurality of connected liquid holder linked units are supported by a specific support means.

In the above embodiment, the description was of a case in which the support means was set in a vertical positional relationship in which the liquid holders constituting the liquid holder linked unit were facing downward and the communicating portions that communicated between the liquid holders were facing upward, but the present invention is not limited to this positional relationship. For instance, the same operation as in the above embodiment will be possible if, when the liquid holders are arranged in a staggered configuration on either side of the communicating tube portion, with the communicating tube portion in the middle, the entire liquid holder linked unit is supported by the support means of the apparatus in a dogleg-shaped configuration whose apex is the communicating tube portion.

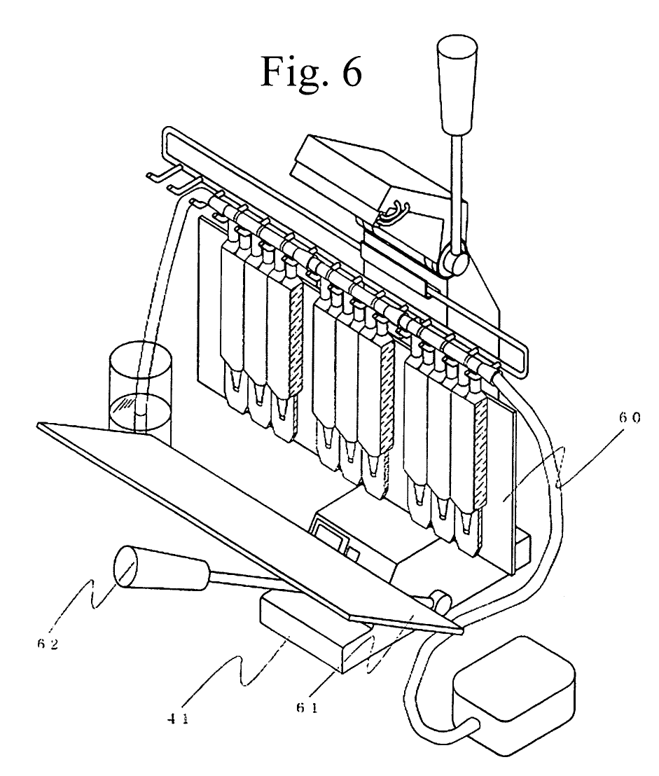

FIG. 6 shows a manufacturing apparatus comprising a pressing mechanism, for pressing on the liquid holders, attached to the manufacturing apparatus used in the embodiment shown in FIG. 5. This manufacturing apparatus has a first pressing plate 60 attached to the main body of the apparatus so as to be at the back of the liquid holder containers, a liquid holder pressing lever 62 of the apparatus main body 41 is further attached, and a second pressing plate 61 is attached to the liquid holder pressing lever 62.

In the embodiment of the manufacturing method of the present invention shown in FIG. 6, prior to step (1) in the step of aliquoting liquid to the liquid holder linked units as discussed above, the liquid holder pressing lever 62 is raised so that the liquid holder linked units are sandwiched between the first pressing plate 60 and the second pressing plate 61. Then, after step (1) in the liquid aliquoting step, the liquid holder pressing lever 62 is lowered to release this pressing. The above-mentioned steps (2) to (4) are performed after the pressing on the liquid holders of the liquid holder linked units has been released. The result of thus including a step of pressing and a step of releasing the pressing is that even if a small amount of the liquid prepared to be held is missing, the volume of the liquid holders will be contracted by an amount equal to the missing prepared liquid by pressing on the liquid holders, so the various liquid holders of each liquid holder linked unit will still contain equal amounts of liquid. In other words, even if the volume of the liquid to be held in the liquid holder linked unit is somewhat smaller than it should be, the missing amount will be uniformly divided up among the liquid holders that make up the liquid holder linked unit, so there will be no instance of just the farthest liquid holder from the liquid supply container 50 ending up with the smallest amount of liquid. That is, even if the amount of drug solution or other liquid is not strictly managed in the preparation of the liquid, the amount of drug solution required for treatment or the like can still be held in the liquid holders, so this embodiment of the manufacturing method of the present invention can be carried out easily.

Also, in the embodiment shown in FIG. 6, the method of the present invention is such that the amount of liquid in the liquid holders can also be adjusted by pressing the liquid holder linked body including liquid in the liquid holders after the liquid has been infused into the liquid holders of the liquid holder linked units. Specifically, after step (1) in the step of aliquoting liquid to the liquid holder linked units as discussed above, the liquid holder pressing lever 62 is raised so that the liquid holder linked units are sandwiched between the first pressing plate 60 and the second pressing plate 61. When the liquid holder linked units are sandwiched between the pair of pressing plates, this contracts the volume of the liquid holders, which reduces the amount of liquid in those liquid holders containing slightly more liquid. At the same time, the amount of liquid held in the liquid holders containing slightly less liquid can be increased by putting the portion discharged from those other liquid holders into these liquid holders. After the amount of liquid has thus been adjusted by pressing on the liquid holder linked body, the pressing of the pressing plates is released. Then, the above-mentioned steps (2) to (4) are performed on the liquid holder linked body from which the pressing has been released. Simultaneously with the above, in the embodiment shown in FIG. 6, as liquid holder linked unit or liquid holding container into which a liquid has been infused can be obtained by performing the above-mentioned step (5) and/or (6). Thus, even if the amount of drug solution or other liquid is not strictly managed in the preparation of the liquid, the amount of drug solution required for treatment or the like can still be held in the liquid holders, so the method of the present invention can be favorably applied not only by pharmaceutical manufacturers, but also in hospitals, pharmacies, and so forth. In the embodiment shown in FIG. 6, a pair of plates apply a force to the liquid holders that presses in opposite directions, but the there are no particular restrictions on the pressing means in the method of the present invention, as long as the volume of the liquid holders or liquid holding container can be reduced. For instance, possible pressing methods other than sandwiching between a pair of plates include a method in which the liquid holders are pressed so as to be surrounded by plates or compressed air.

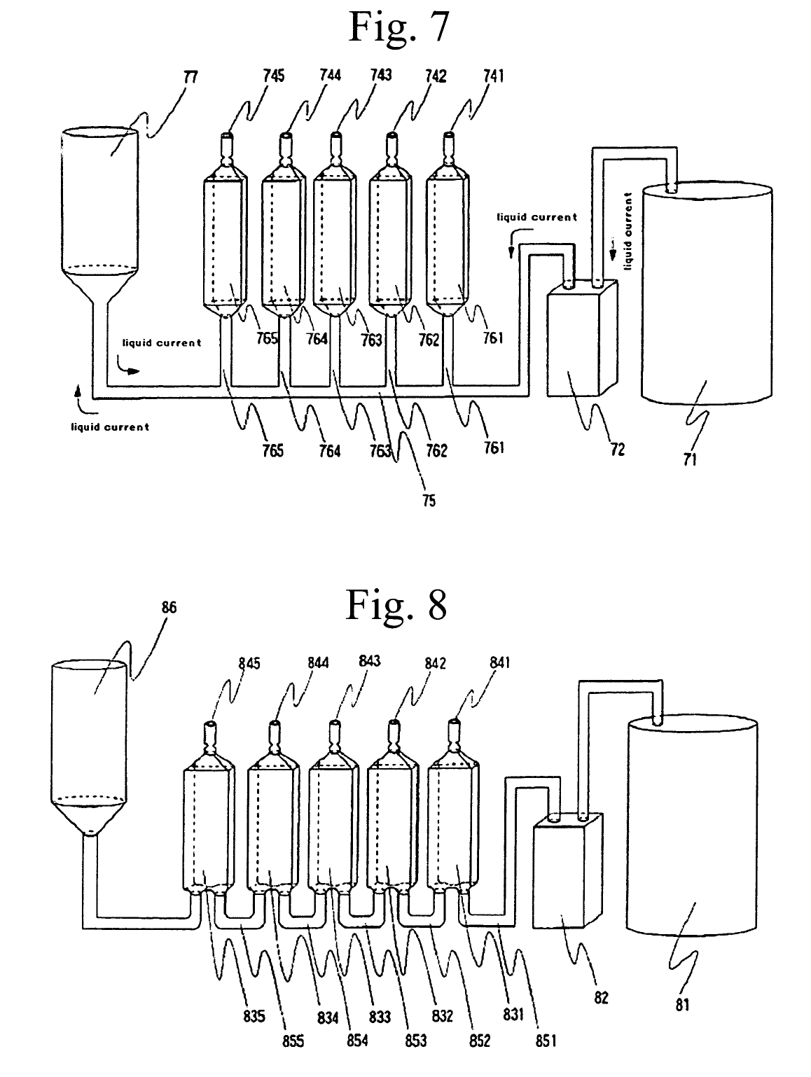

FIG. 7 illustrates the method of the present invention for manufacturing a liquid holding body. Liquid holding containers 731 to 735 are connected to a liquid discharge pipe 75 via communicating portions 761 to 765, respectively. A pump 72 draws out the liquid held in a liquid supply container 71, and pumps it to the liquid discharge pipe 75. The liquid pumped by the pump goes through the liquid discharge pipe and then the communicating portions, into the liquid holding containers, and the liquid discharge pipe and the communicating portions form a liquid channel. The liquid holding containers are connected to the liquid channel formed by the liquid discharge pipe and the communicating portions, and are thereby connected in parallel to each other via the liquid channel.

In FIG. 7, the liquid holding containers are installed with clamps or another such known fixing device (not shown) so that the liquid channel consisting of the communicating portions and the liquid discharge pipe is at the bottom, and openings 741 to 745 are at the top. The liquid pumped by the pump 72 flows into the liquid holding containers, and the gas inside the liquid holding containers is discharged from the openings 741 to 745. These openings function as vent holes so that the gas inside the liquid holding containers will be discharged, which allows the liquid to fill the liquid holding containers more easily.

Further, in FIG. 7, a reservoir tank 77 is connected to the liquid discharge pipe. The reservoir tank 77 is not necessarily required with the method for manufacturing a liquid holding body of the present invention. However, it is preferable for a reservoir tank to be connected to the liquid channel because it allows the height of the liquid level within the liquid holding containers to be adjusted more easily. The liquid supply container and the reservoir tank are equipped with internal pressure adjustment means, such as vent holes, but these are not shown.

When a specific amount of liquid has been pumped into the liquid holding containers, the communicating portions are closed off. In this closure, if the material forming the communicating portions is a thermoplastic resin in the form of a tube, these portions can be closed off simply by heat-fusing the outer walls of the tubular material. This closure can also be accomplished by heat-fusing the outer walls of the tubular material forming tubes 781 to 785 provided between the liquid holding containers and the openings 741 to 745, respectively. This gives a liquid holding body constituted by a single liquid holding container into which a specific amount of liquid has been infused. Thus, a liquid holding body containing a specific amount of liquid can be easily manufactured on-site at a pharmacy or clinic, without a large-scale apparatus being necessary.

FIG. 8 is a diagram of another embodiment of the method for manufacturing a liquid holding body of the present invention. In the embodiment shown in FIG. 8, each liquid holding container is equipped with two connection openings to the liquid channel, the liquid holding containers are connected together by individual liquid channels. With the embodiment in FIG. 7, the liquid holding containers are connected in parallel, but with the embodiment in FIG. 8, the liquid holding containers are connected serially. With the embodiment in FIG. 8, a pump 82 connected to a liquid supply container 81 is connected via a first liquid channel 851 to a first liquid holding container. The first liquid holding container is connected via a second liquid channel 852 to a second liquid holding container. Thus, the liquid holding containers are connected by separate liquid channels, and are connected in series. In the method of the present invention for manufacturing a liquid holding body, the liquid pumped by the pump first flows into a liquid holding container connected by a liquid channel to the pump, and then flows successively into the other liquid holding containers. Once a specific amount of liquid has flowed into the liquid holding containers, the communicating portions are closed off. In this closure, if the material of which the communicating portions are formed is a thermoplastic resin in the form of a tube, these portions can be closed off simply by heat-fusing the outer walls of the tubular material. This closure can also be accomplished by heat-fusing the outer walls of the tubular material forming tubes provided between the liquid holding containers and the openings. This gives a liquid holding body constituted by a single liquid holding container into which a specific amount of liquid has been infused. Thus, a liquid holding body containing a specific amount of liquid can be easily manufactured on-site at a pharmacy or clinic, without a large-scale apparatus being necessary. The reservoir tank and the liquid supply container are the same as in the embodiment shown in FIG. 7. Also, just as with the embodiment of FIG. 7, the pump, reservoir tank, liquid supply container, and liquid channels can be known technology. In the embodiments in FIGS. 7 and 8, another known apparatus capable of liquid suction and discharge can be used instead of a pump, and any known apparatus capable of suction and discharge, be it mechanically driven or manual, can be used.

With the method of the present invention for manufacturing a liquid holding body, a thermoplastic synthetic resin can be used favorably for the liquid holding containers in the embodiments in FIGS. 7 and 8 because such resin is easy to mold, and a thermoplastic resin based on a polyolefin or polyester can be used to particular advantage. There are no particular restrictions on the material of which the liquid channels are made, but these channels, just like the liquid holding containers, are preferably made of a thermoplastic resin because this facilitates closure. If the liquid channels include communicating portions, it is preferable for at least the communicating portions to be made of a thermoplastic resin. In terms of achieving good closure, it is preferable for the liquid holding containers, the tubes, and the liquid channels, or for the liquid holding containers, the liquid holding containers, the tubes, and the liquid channels to be integrally molded. Just as in the embodiments shown in FIGS. 7 and 8, it is preferable for the tubes to have a constricted portion because this allows the tubes to be unsealed more easily by cutting the constricted portions.

The method of the present invention for manufacturing a liquid holding body can also be such that the liquid holding containers are filled with liquid and a liquid holding body is obtained after the liquid holding containers have first been pressed to [contract] their volume, just as with the above method for manufacturing a liquid holder linked body. As discussed above, with a method for manufacturing a liquid holding body that includes this pressing step, it is easier to adjust the amount of liquid in the liquid holding containers, so there is no need for the amount of liquid filling to be strictly adjusted, and it is easier to manufacture a liquid holding body. Also, liquid holding bodies in which the containers hold different amounts of liquid can be manufactured in a single operation by pressing certain liquid holding containers. For example, a manufacturing method that includes a pressing step can be used favorably when the dose is different in a certain time period during the day.

Also, with the method of the present invention for manufacturing a liquid holding body, the liquid holding containers may be used as liquid holders, and these liquid holding containers may be linked so that a plurality of liquid holding containers are used as a liquid holder linked unit. In this case, the method of the present invention for manufacturing a liquid holding body can be used as a method for manufacturing a liquid holder linked body into which a liquid has been infused.

The “liquid holder linked unit” discussed above refers to a unit that is made up primarily of a specific number of liquid holders, and constitutes one unit of a liquid holder linked body. That is, as is clear from the above description, the number of liquid holders included in a liquid holder linked body is the product of multiplying the number of liquid holders included in a liquid holder linked unit by the number of liquid holder linked units.

Embodiments in which the intended application is an ingested drug solution or an antiseptic drug solution were described above as embodiments in which the present invention can be effectively employed, but the present invention can also be used favorably in applications in which liquids are frequently used in specific amounts, such as injection solutions, parenterally administered liquids, such as drug solutions used for ear, nose, and throat, collutories that are not swallowed but are used for disinfection, disinfectants used in the course of surgery and other such treatments, cleaning solutions used to clean contact lenses and the like, bodily fluids used for testing, and other such liquids, as well as in diet liquids such as food additives and flavorings.

### INDUSTRIAL APPLICABILITY

Also, a drug can be prescribed in an accurate blend amount according to the symptoms, without the patient having to measure a single dose of a prescribed drug by eye from a plastic container or the like, so the optimal therapeutic effect can be obtained, and there will be no unevenness in the amounts in which some components, such as settled components, are ingested, so these components will not be taken in too small an amount, nor will there be the danger of side effects caused by taking them in too large an amount. Furthermore, since the patient does not break the seal until the drug is to be used, no bacteria can get into the drug during its storage, and the drug solution will not be accidentally spilled during its handling, so this system is hygienic and also solves problems associated with pharmaceutical management. In addition, the method of the present invention for manufacturing a liquid holder linked body not only solves the problems discussed above, but also greatly improves the time-consuming aliquoting work performed by not only by pharmaceutical manufacturers, but also prescriptionists in hospitals, pharmacies, and so forth, and large quantities of liquid can be aliquoted efficiently and in a short time, which greatly enhances work efficiency. The liquid holder linked body of the present invention, and the method for manufacturing the same, can be used favorably for medical purposes.

1. A liquid holder linked body, comprising liquid holder linked units each provided with an open inlet, an open outlet, and a plurality of liquid holders capable of holding a single-use amount of liquid, wherein the outlet of one liquid holder linked unit is detachably fitted to the inlet of another liquid holder linked unit to integrally connect a plurality of liquid holder linked units together, and all of the liquid holder linked units from the first inlet to the last outlet communicate with each other.

2. The liquid holder linked body according to claim 1, wherein the liquid that is held is a drug.

3. The liquid holder linked body according to claim 1, wherein the liquid that is held is a bodily fluid.

4. The liquid holder linked body according to claim 1, wherein the liquid that is held is a flushing liquid.

5. The liquid holder linked body according to claim 1, wherein the liquid that is held is a diet liquid.

6. A method for producing a liquid holder linked body into which a liquid has been infused, wherein, using a liquid holder linked body comprising liquid holder linked units each provided with an open inlet, an open outlet, and a plurality of liquid holders capable of holding a single-use amount of liquid, in which the outlet of one liquid holder linked unit is detachably fitted to the inlet of another liquid holder linked unit to integrally connect a plurality of liquid holder linked units together, and all of the liquid holder linked units from the first inlet to the last outlet communicate with each other, a liquid is infused into the entire liquid holder linked body through the first inlet, after which the communicating portions between adjacent liquid holders of all the liquid holder linked units, and the communicating portions from the liquid holders of each liquid holder linked unit to the inlet and outlet of that liquid holder linked unit are closed off, and a single-use amount of liquid is infused into all of the liquid holders.

7. The method for producing a liquid holder linked body into which a liquid has been infused according to claim 6, wherein the closure of the communicating portions between adjacent liquid holders of all the liquid holder linked units, and the communicating portions from the liquid holders of each liquid holder linked unit to the inlet and outlet of that liquid holder linked unit is accomplished by heat-sealing the outer wall material that makes up the communicating portions, thereby blocking off these portions.

8. The method for producing a liquid holder linked body into which a liquid has been infused according to claim 6, wherein the liquid that is held is a drug.

9. An apparatus for producing a liquid holder linked body into which a liquid has been infused, by the method for producing a liquid holder linked body into which a liquid has been infused according to any of claim 6, using the liquid holder linked body comprising liquid holder linked units each provided with an open inlet, an open outlet, and a plurality of liquid holders capable of holding a single-use amount of liquid, wherein the outlet of one liquid holder linked unit is detachably fitted to the inlet of another liquid holder linked unit to integrally connect a plurality of liquid holder linked units together, and all of the liquid holder linked units from the first inlet to the last outlet communicate with each other.

10. The method for producing a liquid holder linked body into which a liquid has been infused according to claim 6, wherein a liquid is infused into the entire liquid holder linked body through the first inlet after at least one of the liquid holders has been pressed, or
at least one of the liquid holders is pressed after a liquid has been infused into the entire liquid holder linked body through the first inlet.

11. The method for producing a liquid holder linked body into which a liquid has been infused according to claim 10, wherein the pressing applied to the pressed liquid holders is released after a liquid has been infused into the entire pressed liquid holder linked body, or
the pressing is released after at least one of the entire liquid holder linked body into which a liquid has been infused has been pressed,
after which:
the communicating portions between adjacent liquid holders of all the liquid holder linked units, and the communicating portions from the liquid holders of each liquid holder linked unit to the inlet and outlet of that liquid holder linked unit are closed off.

12. The method for producing a liquid holder linked body into which a liquid has been infused according to claim 10, wherein the pressing applied to the liquid holders is performed by applying pressure to the liquid holders so that the volume of the liquid holders is reduced to between 70 and 95% of the volume of the liquid holders prior to pressing.

13. The method for producing a liquid holder linked body into which a liquid has been infused according to claim 6, wherein the pressing step in which pressing is performed is performed by sandwiching the liquid holders between a pair of flat plates.

14. A method for manufacturing a liquid holding body comprising a liquid holding container and a liquid that is held inside said liquid holding container,
wherein a plurality of said liquid holding containers are connected to a liquid channel,
the plurality of connected liquid holding containers are disposed so that the liquid channel is below and an opening is above,
the opening functions as a vent hole,
the liquid holding body which includes one or more liquid holding containers and in which a specific amount of liquid has been infused into the liquid holding containers is obtained by conducting,
a step of allowing a liquid to flow into a liquid channel and thereby causing the liquid to flow into each of the disposed liquid holding containers, and
a step of halting the flow of liquid at the point when the liquid level reaches a specific position in each liquid holding container are performed, and
a step of closing off said liquid channel and a step of closing off the openings of the liquid holding containers are performed after the flow of liquid has been halted.

15. The method for manufacturing a liquid holding body according to claim 14, wherein the liquid holding containers have a volume capable of holding a single-use amount of liquid.

16. The method for manufacturing a liquid holding body according to claim 14, wherein a liquid holding container is used as a liquid holder, and the liquid holder linked body into which a liquid has been infused is a liquid holding body.

17. The method for manufacturing a liquid holding body according to claim 14, wherein a liquid is infused into each of the liquid holding containers after at least one of the liquid holding containers has been pressed, or
at least one of the liquid holding containers is pressed after a liquid has been infused into the liquid holding containers.

18. The method for manufacturing a liquid holding body into which a liquid has been infused according to claim 17, wherein the step of closing off the liquid channel is performed after
a step of releasing the pressing applied to the pressed liquid holding containers after liquid has been infused into the pressed liquid holding containers, or
a step of releasing the pressing after pressing at least one of the liquid holding containers into which a liquid has been infused
has been performed.

19. The method for producing a liquid holding body into which a liquid has been infused according to claim 17, wherein the pressing applied to the liquid holding containers is performed by applying pressure to the liquid holding containers so that the volume of the liquid holding containers is reduced to between 70 and 95% of the volume of the liquid holding containers prior to pressing.

20. The method for producing a liquid holder linked body according to claim 17, wherein the pressing step in which pressing is performed is performed by sandwiching the liquid holders between at least two flat plates.
